(19) United States
(12) Patent Application Publication
(10) Pub. No.: US 2026/0075481 A1
(43) Pub. Date: Mar. 12, 2026

(54) MANAGING CALL AND MESSAGE CONTINUITY (CMC) SESSION

(71) Applicant: SAMSUNG ELECTRONICS CO., LTD., Suwon-si (KR)

(72) Inventors: Naveen KOLATI, Bengaluru (IN); Prasenjit CHAKRABORTY, Bengaluru (IN); Ravi SURANA, Bengaluru (IN); Ashish KUMAR, Bengaluru (IN); Siva Prasad GUNDUR, Bengaluru (IN); Venkatesh GOWNI RAMAKRISHNA, Bengaluru (IN); Abhishek SONI, Bengaluru (IN); Akshobhya, Bengaluru (IN); Aranya SAMAIYAR, Bengaluru (IN); Rohit PANDEY, Bengaluru (IN); Dhruvil DHOLARIYA, Bengaluru (IN)

(73) Assignee: SAMSUNG ELECTRONICS CO., LTD., Suwon-si (KR)

(21) Appl. No.: 19/394,345

(22) Filed: Nov. 19, 2025

Related U.S. Application Data
(63) Continuation of application No. PCT/KR2024/007810, filed on Jun. 7, 2024.

(30) Foreign Application Priority Data
Jun. 7, 2023 (IN) 202341039095
Feb. 15, 2024 (IN) 202341039095

(51) Int. Cl. H04W 36/00; H04W 36/08; H04W 36/30; H04W 76/10

(52) U.S. Cl. CPC H04W 36/008357; H04W 36/08; H04W 36/30; H04W 76/10

(57) ABSTRACT

A primary device for managing a Call and Message Continuity (CMC) session includes a CMC controller configured to receive capability information of a plurality of secondary devices from a CMC server; receive a communication request message from a remote device, in which the communication request message includes a plurality of media parameters of the remote device; select a secondary device from the plurality of secondary devices by forwarding the communication request message comprising the plurality of media parameters to the CMC server; receive a communication accept message from the CMC server, wherein the communication accept message comprises at least one negotiated media parameter from the plurality of media parameters by the selected secondary device for the CMC session; forward the communication accept message received from the CMC server to the remote device; and initiate a media data transfer between the remote device and the selected secondary device.

### CROSS-REFERENCE TO RELATED APPLICATION(S)

This application is a continuation of International Application No. PCT/KR2024/007810, filed on Jun. 7, 2024, which claims priority to Indian Patent Application number 202341039095, filed on Feb. 15, 2024 in the Indian Patent Office, and Indian Patent Application number 202341039095, filed on Jun. 7, 2023, the disclosures of which are incorporated by reference herein their entireties.

### BACKGROUND

### 1. Field

The present disclosure is related to wireless communication in electronic devices. More particularly the present disclosure is related to managing Call and Message Continuity (CMC) session between a primary device and secondary devices.

### 2. Description of Related Art

Currently, the electronic devices having a feature of Call and Message Continuity (CMC) helps to continue messaging or calling from any device a user is using. The CMC synchronizes calls and messages across the electronic devices. The CMC also includes call forking, call transfers, message synchronizing, and log synchronizing between the electronic devices. The CMC includes two types of electronic devices such as a primary device and secondary devices. The primary device generally has a SIM and can initiate a multimedia communication between a remote device and the primary device. Secondary devices may or may not have a Subscriber Identification Module (SIM), but will be connected to the primary device via Wi-Fi or any local connection. When a secondary device initiates multimedia connection to the remote device via the primary device, a CMC session is established between the primary and the secondary device, followed by an operator network session being established between the primary and remote device. When a remote device initiates a multimedia communication to the primary device, a CMC session will also be established between the primary and all connected secondary devices. The user can receive a call from the primary device or the secondary device. The user can also receive the call in the primary device, and later switch to the secondary device to continue the call on the secondary device. Later, the user can also switch back to primary from secondary device and continue call on primary device.

FIG. 1 is a sequence diagram illustrating CMC flows. The primary device and the secondary device may be used by one user. The secondary device may not communicate with the remote device directly. The secondary device may communicate with the remote device through the primary device. The caller device dials a number to connect to the primary device using a Session Initiation Protocol (SIP) invite message sent from the remote caller to the primary device, the invite message contains the capability details of remote caller device. The invite message received in the primary device and the primary device initiates a new invite towards the CMC server based on capabilities of the primary device. The CMC server determines all the available secondary devices and transfers the new invite to all the available secondary devices. An incoming call notification is shown in both the primary device and the available secondary devices. If the call or the communication request is accepted in the primary device, then single session is created that is one Volte/Vilte/Operator network session (101) between the remote device and the primary device (best suited media parameters supported by both remote and primary device are selected when sending 200 ok to remote device). If the call is accepted from the secondary device, then two sessions are created (102) and (103). A first session is the Volte/Vilte/Operator network session between the remote device and the primary device (based on the remote device and the primary device capability) (105). A second session is the CMC session between the primary device and the secondary device (based on the primary device and the secondary device capability) (106). When negotiated media parameters are different between the CMC session and the Volte/Vilte/Operator network session, then the primary device may be required to de-packetize, decode each Real-Time Transport Protocol (RTP) packets, then encode and packetize before forwarding to or from secondary devices, which increases power usage in the primary device, and overall end to end delay will also increase because of extra processing in the primary device. When the call is ended by the remote or primary or secondary device, both the Volte and the CMC sessions are cleared and the user is notified on all the devices. The media parameters negotiation is performed between the primary device and the remote device, which is based on the capabilities of the primary and remote devices. The negotiation between the secondary device and primary device happens based on capabilities of the primary and secondary devices. Even if the secondary device is more capable than the primary device, those capabilities cannot be fully utilized if the primary device through which the secondary device is connected to remotely is less capable. Therefore, there is a need for a method and a device to enhance calling using capability aware CMC. Furthermore, there is a need to enrich the CMC feature and provide better Quality of Experience (QoE) to users when using highly capable secondary devices.

### SUMMARY

The principal object of the embodiments herein is to provide methods and the devices for managing CMC session between a primary device and secondary devices. The CMC session is managed by establishing a communication between a primary device and a secondary device based on capability information.

Another object of the embodiments herein is to receive capability information from secondary devices on demand or one time or periodic basis. Each secondary device shares the associated media capabilities to primary device and the capability information can be used for negotiation and call recommendation.

Another object of the embodiments herein is to negotiate media attributes based on end device capabilities (where the session is currently active). Based on end device where the call is accepted, new method of media parameters negotiation flows proposed to give the better quality of experience.

Another object of the embodiments herein is to provide a recommendation of an optimal secondary device on which the quality of experience is better. A recommendation notification is displayed to the user on the primary device, recommending the optimal secondary device to receive the call.

Another object of the embodiments herein is to provide renegotiation of media parameters between the electronic devices to maintain same media parameters in Volte and CMC session to avoid transcoding the media in primary device.

According to an aspect of the disclosure, a primary device for managing a Call and Message Continuity (CMC) session includes: memory storing one or more instructions; at least one processor; communication circuitry; and a CMC controller communicatively coupled to the memory, the at least one processor and the communication circuitry, in which the one or more instructions, when executed by the CMC controller, cause the primary device to: receive, capability information of a plurality of secondary devices from a CMC server; receive a communication request message from a remote device to establish an operator network session and the CMC session with the primary device, wherein the communication request message comprises a plurality of media parameters of the remote device; select a secondary device from the plurality of secondary devices based on the capability information of each of the plurality of secondary devices and the plurality of media parameters received from the remote device; establish the CMC session with the selected secondary device by forwarding the communication request message comprising the plurality of media parameters to the CMC server; receive a communication accept message from the CMC server, wherein the communication accept message comprises at least one negotiated media parameter from the plurality of media parameters by the selected secondary device for the CMC session; forward the communication accept message received from the CMC server to the remote device; and initiate a media data transfer between the remote device and the selected secondary device.

The communication request message comprising the plurality of media parameters is forwarded to the selected secondary device without stripping any of the plurality of media parameters received in the communication request message.

The communication accept message comprising the at least one negotiated media parameter is forwarded to the remote device without stripping any negotiated media parameter received in the communication accept message.

The one or more instructions, when executed by the CMC controller to initiate the media data transfer between the remote device and the selected secondary device, further cause the primary device to: receive one or more media data packets from the remote device during the operator network session, wherein the one or more media data packets are to be transmitted to the selected secondary device; and forward the one or more media data packets received from the remote device to the selected secondary device during the CMC session, wherein the one or more media data packets are forwarded to the selected secondary device without transcoding any of the one or more media data packets by the primary device.

The one or more instructions, when executed by the CMC controller to initiate the media data transfer between the remote device and the selected secondary device, further causes the primary device to: receive one or more media data packets from the selected secondary device during the CMC session, wherein the one or more media data packets are transmitted to the remote device; and forward the one or more media data packets received from the selected secondary device to the remote device during the operator network session, wherein the one or more media data packets are forwarded to the remote device without transcoding any of the one or more media data packets by the primary device.

The one or more instructions, when executed by the CMC controller further cause the primary device to: detect a trigger event associated with the selected secondary device; transmit a communication-pull notification message to the selected secondary device; terminate the CMC session between the primary device and the selected secondary device; renegotiate at least one selected media parameter from the plurality of media parameters for the operator network session with the remote device based on the capability information of the primary device; and continue the media data transfer between the primary device and the remote device based on the at least one negotiated media parameter.

The one or more instructions, when executed by the CMC controller further cause the primary device to: detect a trigger event associated with the primary device; establish the CMC session between the primary device and the selected secondary device; renegotiate at least one media parameter from the plurality of media parameters for the CMC session and the operator network session with the remote device based on the capability information of at least one secondary device from the plurality of secondary devices; and continue the media data transfer between the remote device and the secondary device based on the at least one negotiated media parameter.

The trigger event is at least one of (i) a level of a battery of the selected secondary device meets a battery threshold, (ii) detecting that a capability of the primary device is more than a capability of the selected secondary device, and (iii) a communication signal strength of the selected secondary device meets a signal strength threshold.

The plurality of media parameters includes a codec resolution, frames per second, a sampling rate, and content information.

According to an aspect of the disclosure, a method for managing a Call and Message Continuity (CMC) session, includes: receiving, by a primary device, capability information of a plurality of secondary devices from a CMC server; receiving, by the primary device, a communication request message from a remote device to establish the CMC session with the primary device, wherein the communication request message comprises a plurality of media parameters of the remote device; selecting, by the primary device, a secondary device from the plurality of secondary devices based on the capability information of each of the plurality of secondary devices and the plurality of media parameters received from the remote device; establishing, by the primary device, the CMC session with the selected secondary device by forwarding the communication request message comprising the plurality of media parameters to the CMC server; receiving, by the primary device, a communication accept message from the CMC server, wherein the communication accept message comprises at least one negotiated media parameter from the plurality of media parameters by the selected secondary device for the CMC session; forwarding, by the primary device, the communication accept message received from the CMC server to the remote device; and initiating, by the primary device, media data transfer between the remote device and the selected secondary device.

The communication request message is received from the remote device to establish an operator network session with the primary device.

The communication request message comprising the plurality of media parameters is forwarded to the selected secondary device without stripping any of the plurality of media parameters received in the communication request message.

The communication accept message comprising the at least one negotiated media parameter is forwarded to the remote device without stripping any negotiated media parameter received in the communication accept message.

The initiating, by the primary device, the media data transfer between the remote device and the selected secondary device further includes: receiving, by the primary device, one or more media data packets from the remote device during an operator network session, wherein the one or more media data packets are to be transmitted to the selected secondary device; and forwarding, by the primary device, the one or more media data packets received from the remote device to the selected secondary device during the CMC session, wherein the one or more media data packets are forwarded to the selected secondary device without transcoding any of the one or more media data packets by the primary device.

The initiating, by the primary device, the media data transfer between the remote device and the selected secondary device further includes: receiving, by the primary device, one or more media data packets from the selected secondary device during the CMC session, wherein the one or more media data packets are to be transmitted to the remote device; and forwarding, by the primary device, the one or more media data packets received from the selected secondary device to the remote device during an operator network session, wherein the one or more media data packets are forwarded to the remote device without transcoding any of the one or more media data packets by the primary device.

According to an aspect of the disclosure, a non-transitory computer readable medium having instructions stored therein, which when executed by a Call and Message Continuity (CMC) controller for managing a CMC session, cause the CMC controller to execute a method including: receiving, by a primary device, capability information of a plurality of secondary devices from a CMC server; receiving, by the primary device, a communication request message from a remote device to establish the CMC session with the primary device, wherein the communication request message comprises a plurality of media parameters of the remote device; selecting, by the primary device, a secondary device from the plurality of secondary devices based on the capability information of each of the plurality of secondary devices and the plurality of media parameters received from the remote device; establishing, by the primary device, the CMC session with the selected secondary device by forwarding the communication request message comprising the plurality of media parameters to the CMC server; receiving, by the primary device, a communication accept message from the CMC server, wherein the communication accept message comprises at least one negotiated media parameter from the plurality of media parameters by the selected secondary device for the CMC session; forwarding, by the primary device, the communication accept message received from the CMC server to the remote device; and initiating, by the primary device, media data transfer between the remote device and the selected secondary device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

This method is illustrated in the accompanying drawings, throughout which like reference letters indicate corresponding parts in the various figures. The embodiments herein will be better understood from the following description with reference to the drawings, in which:

FIG. 1 is a sequence diagram of a CMC flow;

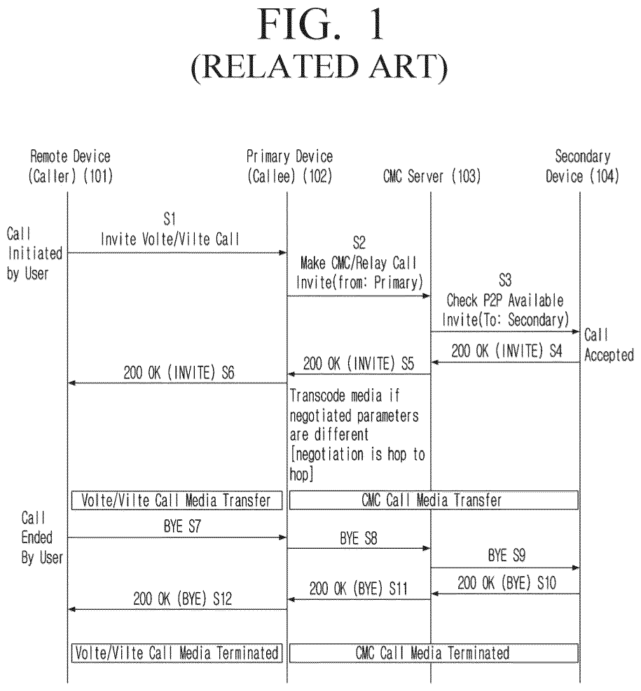

FIG. 2 is a schematic representing a flow of a caller device establishing a communication session with the electronic device;

FIG. 3 is a schematic representing a flow of the caller device (102a) establishing the communication session with the primary device (102b), and the primary device (102b) establishing the communication session with secondary device (104) for enhanced calling using capability information, according to the embodiments herein;

FIG. 4 is a sequence diagram illustrating the caller device or remote device (101) initiating the communication with an end user based on the capability information of the various electronic devices, according to the embodiments herein;

FIG. 5 is a schematic illustrating a number of sessions established between the caller device (101) and the end user or the electronic device and media flow between electronic devices;

FIG. 6 is a schematic illustrating a number of sessions established between the caller device and the end user of the electronic device, and media flow between electronic devices, according to the embodiments herein;

FIG. 7 is an example for a call initiation between two Video See through (VST) devices;

FIG. 8 is an example for a call initiation between the two VST devices, according to the embodiments herein;

FIG. 9 is a flow diagram for managing the call and message continuity session between the primary device (102) and the secondary device (104), according to the embodiments herein;

FIG. 10 is a sequence diagram illustrating an instance of receiving the call in the secondary device (104) and later pulled in the primary device (102), according to the embodiments herein;

FIG. 11 is a sequence diagram illustrating an instance of receiving the call in the primary device (102) and later pulled in the secondary device (104), according to the embodiments herein;

FIG. 12 is a sequence diagram illustrating an instance of a 2D call between the electronic devices which are even capable of 360 degree or 3D call;

FIG. 13 is a sequence diagram illustrating an instance of 2D call between the electronic devices, which are even capable of 360 degree or 3D call;

FIG. 14 is a sequence diagram illustrating an instance of a 360 degree or 3D video call between the electronic devices based on capabilities synced with associated the primary device, according to the embodiments herein;

FIG. 15 is a sequence diagram illustrating an instance of a call pull in a case of 360 degree or 3D video call between the electronic devices based on capabilities synced with associated the primary device, according to the embodiments herein;

FIG. 16 is a block diagram illustrating a primary device for managing a CMC session between the primary device and secondary devices, and operator network call between primary and remote device according to the embodiments herein; and

FIG. 17 is a block diagram illustrating the secondary device for managing a CMC session between the primary device and secondary devices, according to the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Generally seamless movement of active media sessions between communication devices occurs. An application is used to facilitate switching of media session between the devices twinned therewith. In an aspect, a first device employing the application generates a request to switch a media session between a second device and a third device to be between the first device and a third device. The application sends the request to Call and Message Continuity (CMC) server. The request includes a first identifier for the first device, a second identifier for the second device and a device switch indicator. The request is configured to initiate a switch of the media session to being between the first device and the third device based on determination that the first device and the second device are associated with a common mobile subscriber identity registered for an account associated with the CMC server. The second device and the third device are the primary devices such as mobile phones and the first device can be laptops, palmtops, tablets, VST, watch, or any other suitable device. However, the present disclosure discloses negotiating the media parameters based on end device capabilities (e.g., not dependent on intermediate device capabilities), when the call is accepted or pulled to an advanced device (such as VST/VR/AR/XR device).

Generally, an accessory wireless device partakes in a data session with a remote device. The data session can be a voice call or other service. To preserve the battery power of the accessory wireless device, the accessory wireless device opportunistically offloads medium-to-long range radio transmission and reception tasks to the companion wireless device while maintaining call continuity. The accessory wireless device and the companion wireless device communicate through a local connection. The accessory wireless device pushes a wireless wide area network (WWAN) connection to the companion device by sharing selected security and network information with the companion wireless device. When the accessory device and/or the companion device determine that the local connection may not be sustainable, the accessory device pulls the WWAN connection of the companion device back to itself. The embodiments of the present disclosure advantageously provide a recommendation to the user, including an optimal electronic device to receive the call. Also, the present disclosure provides a solution for media quality improvement when the call is between the two advanced devices. Instead, medium may be generally offloaded to long range wireless transmission and reception tasks to a second wireless device, while enjoying the utility of the accessory wireless device to save the battery in the accessory wireless device.

The present disclosure includes receiving or transmitting capability information by a CMC server on demand, one time, or on a periodic basis. Each secondary device shares the media capabilities to an associated primary device through the CMC server, where the capability information may be used for negotiation and call recommendation. Also, the present disclosure includes negotiating media attributes based on end device capabilities (end devices where the session is currently active). Based on the end device where the call is accepted, new methods of media parameters negotiation flows are disclosed to give a better quality of experience. The end device nay be the primary device or the secondary device, from which the call is accepted/initiated.

The present disclosure includes a recommendation of an optimal electronic device on which the quality of experience (QoE) is better. A recommendation notification is displayed to the user on the primary device, recommending the optimal electronic device to receive the call.

The present disclosure includes renegotiating the media parameters between the electronic devices to maintain same media parameters in Volte and the CMC session without transcoding the media in primary device.

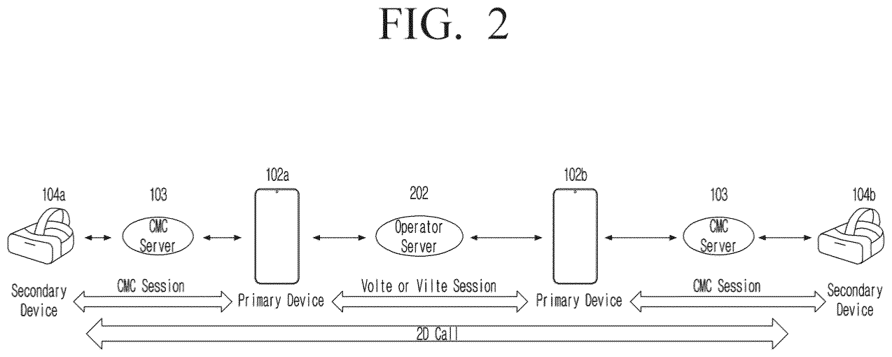

FIG. 2 is a schematic representing a flow of a caller device establishing a communication session with the electronic device. The schematic diagram includes hardware components such as a secondary device (104a, 104b), a primary device (102a & 102b), an operator server (202), and a CMC server (103). The CMC system includes two types of devices. The primary device (102a) (e.g., smartphone) and the secondary device (104a) (e.g., AR/VR device) are used by User A. The secondary device (104a) may not communicate with the primary device (102b) or the secondary device (104b) directly. The secondary device (104a) may communicate with the primary device (102b) or the secondary device (104b) through the primary device (102a). The primary device (102b) (ex: smartphone) and the secondary device (104b) (ex: AR/VR device) are used by User B. The secondary device (104b) may not communicate with the primary device (102a) or the secondary device (104a) directly. The secondary device (104b) may communicate with the primary device (102a) or the secondary device (104a) through the primary device (102b). The first device can be the primary devices (102a & 102b), which generally have a SIM, and the second device which may have or may not have the SIM to initiate the call or to answer the all. Generally, whenever a call is handled by the secondary devices (104a & 104b), even though the secondary devices (104a & 104b) are capable of better call experience (such as 360/3D call, spatial audio and the like), but the secondary devices end up not utilizing these capabilities if one of the primary devices (102a & 102b) with which one of the secondary devices is connected has low capabilities (ex: supports only 2D call). This lack of utilization occurs because, media parameters negotiation happens based on the capabilities of the primary devices (102a & 102b) and not on the basis of the capabilities of the secondary devices (104a & 104b) where the session is currently active. The primary devices (102a & 102b) transcode, when negotiated parameters are different between VoLTE (session between the primary device and remote) and the CMC session (session between primary device and the secondary devices), which increases end to end delay and also increases power usage in the primary devices (102a & 102b).

In one or more examples, the secondary devices (104a & 104b) are capable of 3D/360 calling, but the primary devices (102a & 102b) are capable of only 2D calling. Therefore, the call established between the two secondary devices (104a & 104b) is a 2D call, even though the both secondary devices (104a & 104b) can support 3D/360 calling, which ends up affecting the user experience.

In another instance, the secondary devices (104a & 104b) can be capable of High Definition (HD) calling, but the primary devices (102a & 102b) are capable of only Quarter Video Graphics Array (QVGA) calling. The call established between the secondary devices (104a & 104b) is a QVGA call even though the secondary devices (104a & 104b) can support HD calling. The secondary devices (104a & 104b) can be capable of spatial audio calling, but the primary devices (102a & 102b) are capable of only mono audio calling. Therefore, the call established between secondary devices (104a & 104b) are mono audio call even though the secondary devices (104a & 104b) can support spatial audio calling.

The secondary devices (104a & 104b) sometimes do not use a SIM and are generally connected to the primary devices (102a & 102b) via Wi-Fi or ay local connection. When the call is between the secondary devices (104a & 104b), where both devices support 3D/360 calling, but the primary devices (102a & 102b) do not support 3D or 360 calling (the primary device only support 2D decoding and rendering), only 2D parameters may be negotiated because a final media parameter selected is the best/optimal common media parameter supported by all devices involved in call. The caller device can also have one of the secondary devices (104a & 104b), and the caller can initiate the call through one of the secondary devices (102a & 102b) to a callee. In one or more examples, the caller device is a device that initiates the communication. In one or more examples, the callee or a receiver device is a device that receives communication from the sender (caller).

The secondary devices (104a & 104b) can be Virtual Reality (VR) device, Video See Through (VST), Augmented Reality (AR) glasses, Mixed Reality (MR) headsets, smartphones with AR capabilities, AR/VR accessories, AR/VR controllers and input devices, AR/VR camera devices, tablets and smart watches and the like. The secondary devices (104a & 104b) can be one and, in some cases, the secondary devices (104a & 104b) can include more than one. The caller device and the receiver device can be both the primary devices (102a & 102b) and the secondary devices (104a & 104b).

The primary devices (102a & 102b) can be a user equipment such as a smartphone. The operator server (202) can be the server that manages and controls operation in network such as routing requests, handling authentication, managing resources, and the like. The CMC server (103) maintains and manages a session between primary and secondary device. The CMC server can store capability information of the secondary devices (104a & 104b), where the capability information will be synced with a primary device one time/on periodic basis, which the primary devices (102a & 102b) can use for determining the optimal secondary devices (104a & 104b) for establishing the communication between the electronic devices. The communication that occurs between the secondary devices (104a & 104b) and the primary devices (102a & 102b) are via a CMC server, and the communication happens between the primary devices (102a & 102b) and remote is via the operator server.

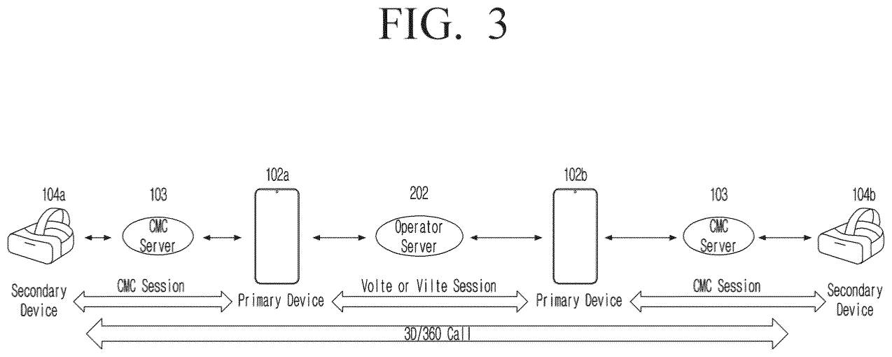

FIG. 3 is a schematic representing a flow of the caller device (102a) establishing the communication session with the primary device (102b) or secondary device (104b) for enhanced calling using capability information, according to the embodiments herein. The primary device (102a) (ex: smartphone) and the secondary device (104a) (ex: AR/VR device) are used by User A. The secondary device (104a) may not communicate with the primary device (102b) or the secondary device (104b) directly. The secondary device (104a) may communicate with the primary device (102b) or the secondary device (104b) through the primary device (102a). The primary device (102b) (ex: smartphone) and the secondary device (104b) (ex: AR/VR device) are used by User B. The secondary device (104b) may not communicate with the primary device (102a) or the secondary device (104a) directly. The secondary device (104b) may communicate with the primary device (102a) or the secondary device (104a) through the primary device (102b).

The secondary devices (104a and 104b) can be Virtual Reality (VR) device, VST, Augmented Reality (AR) glasses, Mixed Reality (MR) headsets, smartphones with AR capabilities, AR/VR accessories, AR/VR controllers and input devices, AR/VR camera devices, tablets and smart watches and the like. In one or more examples, as understood by one of ordinary skill in the art, the number of secondary devices may range from one device to any suitable number of devices. The caller device and the receiver device can be both the primary devices (102a and 102b) and the secondary devices (104a and 104b).

The primary devices (102a and 102b) can be a user equipment such as a smartphone. The operator server (202) can be the operator server (202) that manages and controls operation in network such as routing requests, handling authentication, managing resources, and the like. The CMC server (103) maintains and manages a session between the primary and the secondary device. The CMC server (103) may store capability information of the secondary devices (104a and 104b), where this capability information will be synced with a primary device one time/on periodic basis, which the primary devices (102a and 102b) can use for determining the optimal secondary device for establishing the communication between the electronic devices. The communication happens between the secondary devices (104a and 104b) and the primary devices (102a and 102b) is via CMC server and the communication happens between the primary devices (102a and 102b) and remote is via the operator server (202). In one or more examples, an optimal secondary device may be a secondary device that meets desired communication quality criteria such as highest bandwidth, lowest delay, etc.

In an example, the secondary devices (104a and 104b) are capable of 3D/360 calling, but the primary devices (102a and 102b) are capable of only 2D calling. Therefore, the call established between the two secondary devices (104a and 104b) is a 3D/360 call, as only end device (two secondary devices) capabilities considered for negotiation of media parameters. This ends up improving the user experience.

In another instance, the secondary devices (104a and 104b) can be capable of High Definition (HD) calling, but the primary devices (102a and 102b) are capable of only Quarter Video Graphics Array (QVGA) calling. The call established between the secondary devices (104a and 104b) may be an HD call, as only end device (secondary device) capabilities are considered for negotiation of media parameters. The secondary devices (104a and 104b) can be capable of spatial audio calling, but the primary devices (102a and 102b) are capable of only mono audio calling. Therefore, the call established between the secondary devices (104a and 104b) are a spatial audio call.

The present disclosure negotiates media parameters for the call based on the capability of respective end devices to improve QoE for the user. The remote device (101) initiates the call to the primary devices (102a and 102b). The remote device (101) can be a caller primary devices (102a and 102b) or a caller secondary device. Referring to the FIG. 3, the call initiated between the caller device and the receiver device in the present disclosure can be a 3D/360 call. The communication between the remote device and the primary device is performed using the operator server (202), and the communication between the secondary devices (104a to 104b) and the primary device (102a) is performed using the CMC server (103).

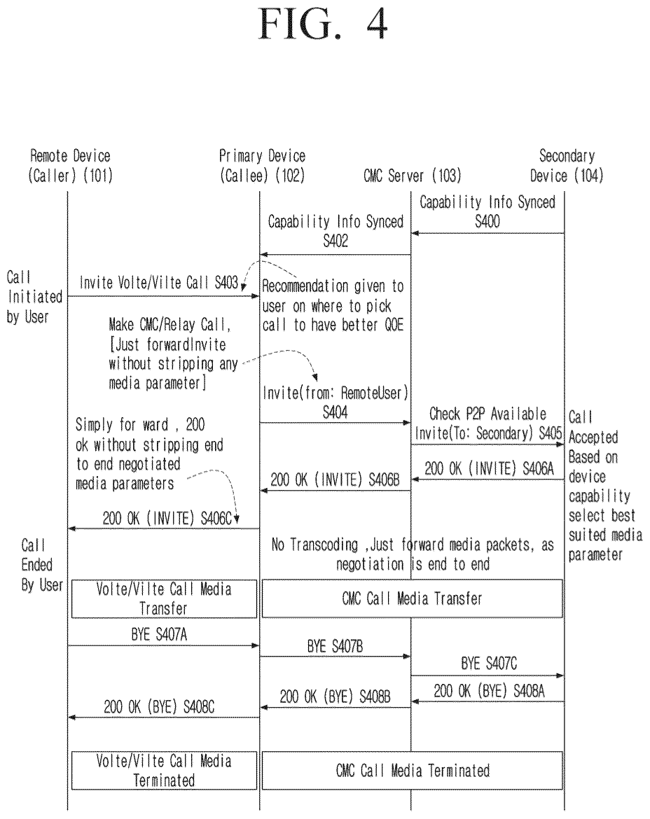

FIG. 4 is a sequence diagram illustrating the caller device or remote device (101) initiating the communication with end user based on the capability information of the various electronic devices, according to the embodiments herein.

Referring to FIG. 4, (at S403) the remote device (101) or the caller device (101) initiates call to the primary device (102). The primary device (102) and all the connected secondary devices receive notification of a call. In an instance, the user accepts the call from the secondary device (104) (at the caller end). The call is established between the secondary device (104) and the remote device (101) or the caller device (the primary device (102) can act as a relay).

At S400 and S402, the CMC server (103) collects the capability information from the secondary device (104) and forwards it to primary device (102). The capability information may comprise media parameters of the devices, audio capabilities, video calling capabilities, haptic, text, sensor, 3D or 360 calling capabilities and the like. The capability information may comprise a plurality of functions provided by the secondary device (104). The capability information of secondary device is synced with the connected primary device (102). The connected primary device (102) is the device to which the secondary device is connected. The capability information can be synced on demand, on a time basis, or periodically. The capability information is collected by the CMC server (103) and stored. The capability information is also synced with the primary device (102) through the CMC server (103).

At S403, the call is initiated by the remote device (101) or the caller device (101). The invite Volte/Vilte/IMS call is transmitted to the primary device (102). The primary device (102) also provides a recommendation to the user. The recommendation can include optimal functions based on the capability information provided by the secondary device (104). The capability information may comprise media parameters of the devices, audio capabilities, video calling capabilities, haptic, text, sensor, 3D or 360 calling capabilities and the like. The capability information may comprise a plurality of functions provided by the secondary device (104).

At S404, an invite is received in the primary device (102). The primary device (102) initiated a call or session using a SIP invite message. The SIP is a Session Initiation Protocol (SIP) is used for initiating and managing communication sessions. the primary device (102) forwards the invite which it received from remote device (101) to the CMC server (103) without striping any media parameters

At S405, Point to Point (P2P) availability is checked at the CMC server (103). An extended invite is transmitted to available secondary devices from the CMC server (103).

At S406A, S406B, and S406C, the primary device (102) forwards the response of secondary device (104) to the remote device (101) without striping any end to end negotiated media parameters. The response can be 200 OK. The 200 OK messages are part of the process of establishing a communication session. The secondary device selects and negotiate the best suited media parameter based on its own capability and the capability information received from the remote devices. The media parameters can be codec resolution, fps, sampling rate, and content information for the CMC and operator network session and the like. The media is flown between the caller device and the secondary device based on the negotiated capability information.

The primary device (102) acts as a relay and do not decode/encode/depacketize/packetize/depacketize any media packets simply forward media packets from the remote device (101) to or from the secondary device.

At S407A, S407B, and S407C, the call is ended by the remote device (101) or the caller device. When the call is ended by the remote user, both the Volte and the CMC session get cleared and the user is notified on all the devices.

At S408A, S408B, and S408C, the call is ended message is accepted at the secondary device and the accept message is transmitted back to the remote device (101) via Primary device. The CMC call media is terminated between the secondary device and the primary device (102). The Volte/Vilte call media is terminated between the primary device (102) and the caller device.

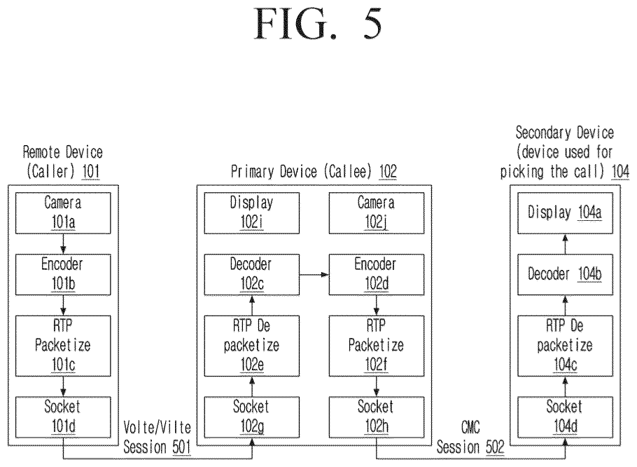

In the embodiments of the disclosure, in FIG. 5, it is explained that there is only one secondary device (104). However, as understood by one of ordinary skill in the art, the embodiments are not limited to this configuration. For example, the primary device (102) may be connected to a plurality of secondary devices. The CMC server (103) collects the capability information from all the secondary devices and forwards the collected capability information to primary device (102). The capability information can be media parameters of the devices, audio capabilities, video calling capabilities, haptic, text, sensor, 3D or 360 calling capabilities and the like. The capability information of all secondary devices is synced with the primary device (102). The capability information can be synced on demand or one time basis or periodically. The primary device (102) provides recommendation to the user optimal secondary device from among the plurality of secondary devices based on the capability information. The optimal secondary device can have a better Quality of Experience (QoE) compared to other secondary devices.

FIG. 5 is a schematic illustrating a number of sessions established between the caller device (101) and the end user or the electronic device. FIG. 5 also shows how media flows between caller device (101) to the secondary device (104). The schematic includes the remote device (101), the primary device (102), and the secondary device (104). The remote device (101) includes a camera (101a), an encoder (101b), RTP packetize (101c), and a socket (101d). The primary device (102) includes a display (102a), a camera (102i), a decoder (102c), an encoder (102d), an RTP depacketize (102e), and an RTP packetize (102f), and socket (102g). The secondary device (104) includes a display (104i), a decoder (104c), an RTP packetize (104c) and a socket (104d). The secondary device (104) is used for picking the call. The communication established between the primary device (102) and the remote device (101) is Volte/Vilte session (501) via operator server. The communication established between the secondary device (104) and the primary device (102) is the CMC session via CMC server (103). As negotiation is performed independently, different media parameters may be negotiated and used in both sessions.

Generally, two sessions are established when the call is established between the remote device (101) and the secondary device (104). The remote device (101) transmits the media content to the primary device (102) based on media parameter negotiation. The primary device (102) receives data from the remote device (101) (on a UDP/RTP socket (101d to 102g). The primary device (102) removes a RTP header in a depacketization process (102e) and decodes the data to get raw data using the decoder (102c), and then based on the CMC call negotiated media parameters, the raw data is encoded again using the encoder (102d). The encoded data is packetized using the RTP packetize (102f) and sent to the secondary device (104) over the CMC session (502). When the encryption is enabled and the primary device (102) encrypt RTP or RTCP packet (using the socket (102h) before forwarding it to the secondary device (104).

The secondary device (104) receives the data from the primary device (102). The secondary device (104) depacketizes (104c) and decodes the data using the decoder (104c) received from the primary device (102). The decoded data is displayed on a User Interface (UI) (104a).

The negotiation may be on a hop to hop basis. One set of media parameters negotiated between the primary device (102) and the remote device (e.g., secondary device in this scenario). Another set of media parameters may be negotiated between the primary device (102) and the secondary device (104). As the media parameters are negotiated in the CMC and Volte session independently, there is a high chance that negotiated media parameters are different between two media sessions, and as a result, the primary device (102) is forced to transcode media data before forwarding the media to the secondary device in the CMC session.

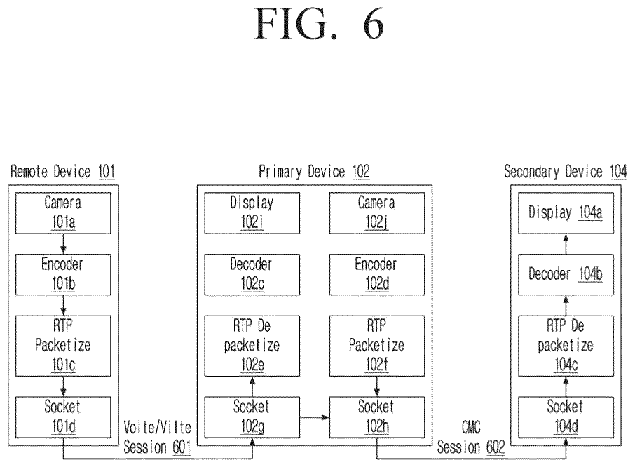

FIG. 6 is a schematic illustrating a media flow between remote, primary and secondary devices for the enhanced calling based on end device capability based negotiation, according to the embodiments herein. The schematic includes the remote device (101), the primary device (102), and the secondary device (104). The remote device (101) includes camera (101a), encoder (101b), RTP packetize (101c), and a socket (101d). The primary device (102) includes a display (102i), a camera (102j), a decoder (102c), the encoder (102d), an RTP depacketize (102e), and an RTP packetize (102f), and socket (102g). The secondary device (104) includes a display (104i), a decoder (104c), an RTP packetize (104c) and a socket (104d). The secondary device (104) is used for picking the call. The communication established between the primary device (102) and the remote device (101) is Volte/Vilte/IMS session (601) via operator server and the communication established between the secondary device (104) and the primary device (102) is the CMC session (602) via CMC server. In the present disclosure, two sessions are established when the call is established between the remote device (101) and the secondary device (104).

A first session is between the primary device (102) and the remote device (101). The first session can be the Volte/Vilte/IMS session. The CMC session (601) is established between the primary device (102) and the secondary device (104) based on the capability information. In one or more examples, the primary device (102) knows the capability information of the secondary device (104) where the call is received, and that secondary device media parameters are used for re-negotiated with the remote device (101) to maintain same media attributes in both the sessions (Volte and CMC).

The remote device (101) transmits the media content based on the secondary device (104) and the remote device media parameter renegotiation. The primary device (102) can receive the data from the remote device (101) (on UDP or RTP socket of Volte session). With less or no processing, the data is pushed to the CMC session using UDP socket (102g, 102h), when the SRTP is enabled then the SRTP is encrypted before forwarding the data. The secondary device (104) receives the data from the primary device (102). The RTP depacketizes (104c) the received data and decodes (using decoder (102c)) the data to display on the UI (104a).

The primary device (102), using a re-negotiation method, makes sure that the operator network call and CMC call will have same media parameters for communication. Generally, two-independent sessions are negotiated. Therefore, transcoding is performed in the primary device (102) if negotiated parameters are different, but in the present disclosure, the re-negotiation method is used to maintain the same media parameters in both calls, so advantageously, no transcoding is required in the primary device.

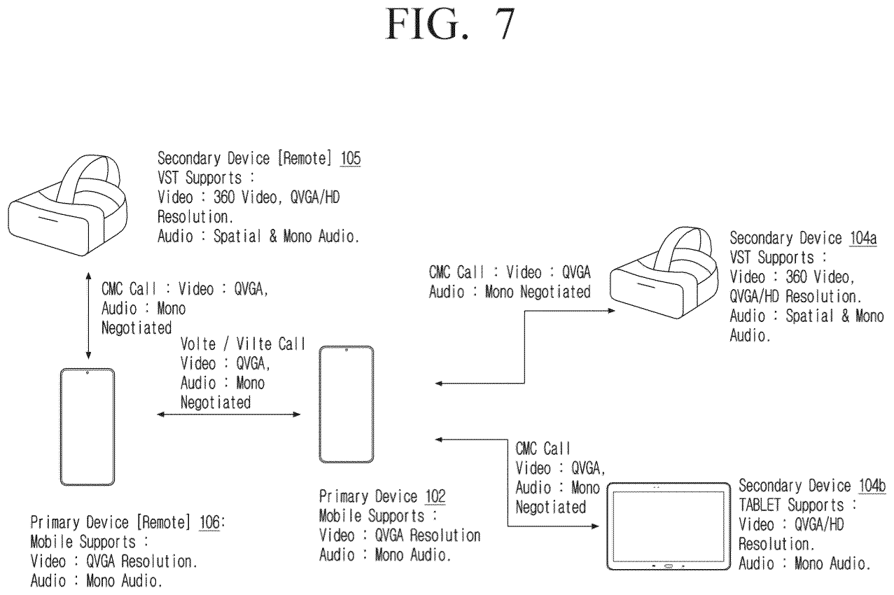

FIG. 7 is an example for a call initiation between two VST devices. The VST is a remote secondary device (105) supporting 360 video, QVGA and HD resolution and audio can be both spatial and mono audio. A remote primary device (106) supports video: QVGA, and mono audio.

The remote secondary device (105), when the device tries to make a call to Primary device (102), a CMC call is initiated between the remote secondary device (105) and the remote primary device (106), where the initiated call will have media parameters based on remote secondary device (105) capability. For example a VST device as the remote secondary device (105) sends 360 video, QVGA and HD resolution for video and spatial and mono for audio. Subsequently, the remote primary device (106) initiates the operator based call with the primary device (102), where an outgoing call will have media (audio, video etc.) parameters based on its own capability and a capability the device received from the remote secondary device (105) (e.g., best possible common media parameters selected). In one or more examples, in a current scenario video, the QVGA and mono audio sent as these are the possible common media parameters supported by both remote device (105 & 106); Call rings on both the device (102) & all secondary devices (104a and 104b), when the primary device (102) receives the call Send a call notification message to secondary devices, and also send media parameters based on own capability and capability the secondary device received from remote primary device (106) (e.g., best possible common media parameters selected). In one or more examples, in the current scenario video (QVGA and mono audio), the primary device (102) supports the QVGA resolution and the mono audio, and the primary device is connected with the two secondary device (104a and 104b). The secondary device (104a) supports 360 video, QVGA/HD resolution and special, mono audio. The secondary device (104b) supports QVGA/HD resolution and the mono audio.

If a user picks a call in the secondary device (104a), then the call will be established between the two VST devices. The audio-mono and video-QVGA resolution is negotiated and used. The primary device (102 and 106) supports max QVGA and mono audio only (even though both VST supports HD video and spatial audio). The parameters are not negotiated or used because the primary device (102 and 106) is not supporting those parameters). If the user picks call in secondary device (104b) then the call between the remote secondary device (105) and the secondary device (104b) (TAB Device) is negotiated with QVGA Resolution and the mono audio as the primary device (102, 106) supports max QVGA video resolution (even though tab (104b) and VST (105) support the HD video, and HD resolution is not selected or used because the primary device (102 and 106) do not support the HD video). As the CMC and Volte call negotiation is performed independently, the primary device (102 and 106) may need to transcode media when negotiated parameters are different between the Volte and CMC Session. Even though end devices (the secondary devices (104a, 104b, 105) are highly capable), the capability information cannot be used to provide good QoE to the user as negotiation and usage of media parameters are restricted because of less capable primary device (102 and 106) through which they are connected to outside world.

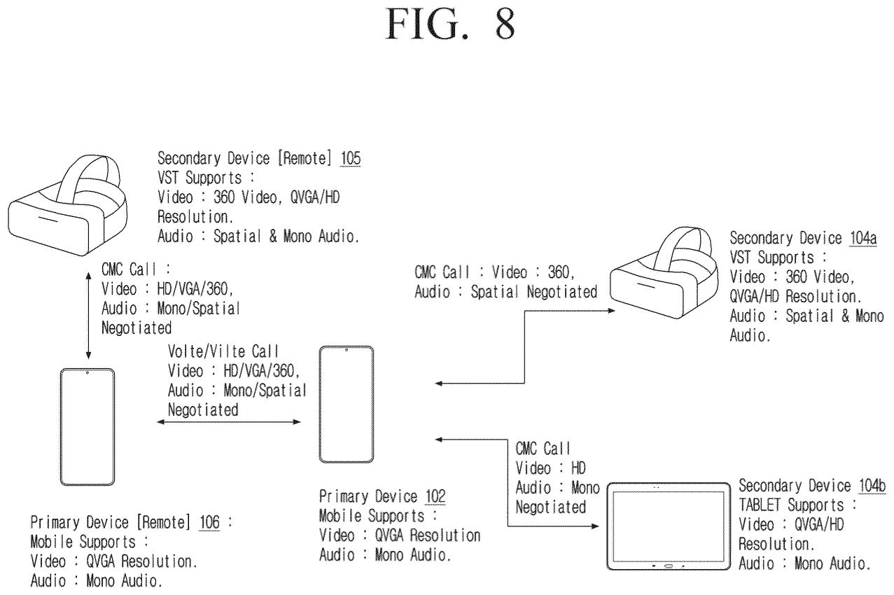

FIG. 8 is an example for a call initiation between the two VST devices, according to the embodiments herein. In a VST call, an actual face of a user is not visible since the user may be wearing a head mount device. As a result, an Avatar image of the user is used for video conversation. In one or more examples, before initiating the call user can generate his avatar image and later use same image in call conversation. The VST is a remote secondary device (105) supporting 360 video QVGA, HD resolution and audio can be both spatial and mono audio. A remote primary device (106) supports QVGA resolution and mono audio.

When the device tries to make a call to Primary device (102), a CMC call is initiated between the remote secondary device (105) and the remote primary device (106). Initiated call will have media parameters based on remote a capability of the secondary device (105). In one or more examples, a VST device as the remote secondary device (105) sends 360 video, QVGA, and HD resolution for video and spatial and mono for audio. Subsequently, the remote primary device (106) initiates the operator based call with the primary device (102). An outgoing call will have media (audio, video etc.) same as it received from Remote secondary device (105). In this regard, the remote primary device (102) will not add its own capability or it will not strip any media parameters, which it won't support. Instead, the remote primary device (102), in one or more examples, copies media parameters received from remote secondary device (105) and forwards the copied parameters to the primary device (102). As a result, in this example, the remote primary device (105) sends a call invitation with 360 video, QVGA and HD resolution for video and spatial and mono for audio media parameters to primary device (102). The call rings on both Primary device (102) and all secondary device (104a and 104b). Primary device (102) supports the QVGA resolution and the mono audio and connected with the secondary device (104a and 104b). The secondary device (104a) supports 360 video, QVGA, HD resolution and special, mono audio. The secondary device (104b) supports QVGA, HD resolution and the mono audio, when the primary device (102) sends call notification messages to secondary devices it will not add its own capability or it will not strip any media parameters which it won't support. Instead, the primary device (102) simply copies media parameters received from remote primary device (106) and forwards the copied parameters to secondary device (104a and 104b).

If the user picks a call in secondary device (104a), then Call will be established between the two VST device (105, 104a) with spatial audio and 360 video parameters (e.g., best possible common media parameters selected). If the user picks a call in secondary device (104b), then the call will be between the VST device (105) and TAB device (104b) with mono audio and HD video resolution. In the present disclosure, negotiation is performed based on the end device capability information, and the primary device (102) acts as the relay (e.g., blind forwarding of received the packets). The capabilities of the primary device (102) are not considered for negotiation, when the call is received in the secondary device (104b), which are highly capable compared to the primary device (102). Transcoding is skipped as same parameters are negotiated or maintained in both the CMC and Volte/Vilte call. The negotiation and usage of parameters is performed based on the end device capability information (e.g., two end points where call is active) not restricted based on the primary device (102,106) capability.

The user can switch between the primary device (102) and the secondary device (104) in below cases:

User can pick/pull call on any device which is closer to the user.

If the primary device (102) is already used for some purpose, then the user can pick the call from the secondary device (104) which is free (vice versa).

If the primary device (102) battery is low, then the user can pick the call from the secondary device (104), which has more battery (vice versa).

If the primary display/memory/CPU/RAM capability is low compared to the secondary device (104), then the user can pick the call from the secondary device (104) for better QoE (vice versa).

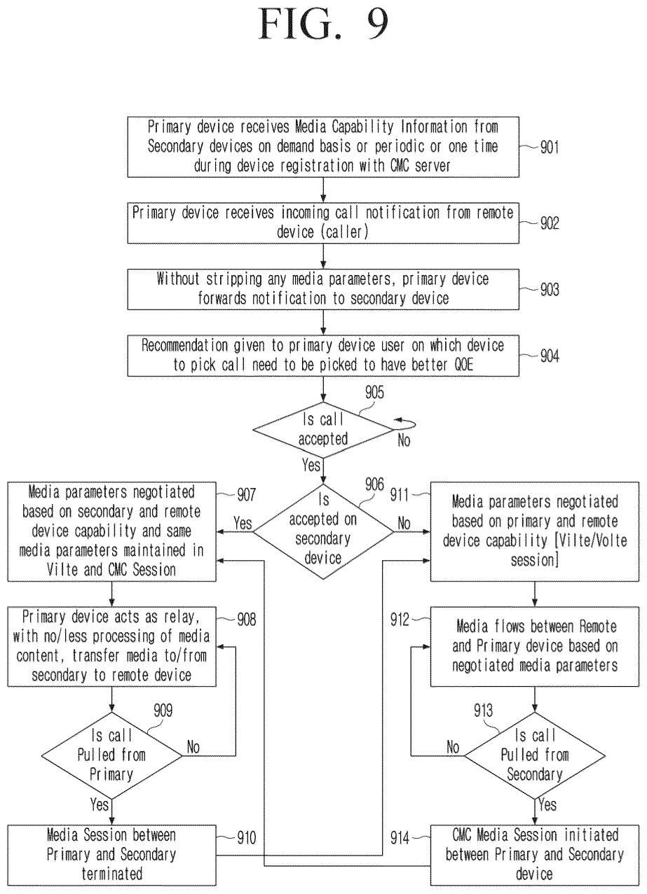

FIG. 9 is a flow diagram for managing the call and message continuity session between the primary device (102) and the secondary device (104), according to the embodiments herein.

At 901, the primary device (102) receives the media capability information from the secondary device (104) on demand basis or periodic or one time during the device registration with the CMC server.

At 902, the primary device (102) receives the incoming call notification from the remote device (106, 105).

At 903, the primary device (102) transmits the notification to the secondary device (104) without stripping the media parameters.

At 904, the primary device (102) is recommended on which device call need to be picked to have better QoE.

At 905, it is determined whether the call is accepted, and if accepted, it is determined when the call is accepted in the secondary device at 906.

At 907, the media parameters are negotiated based on the secondary device (104) and the remote device (106, 105) capability and same media parameters maintained in the Vilte and CMC session.

At 908, the primary device (102) acts as the relay, with little to no processing of media content, and transfers the media content to/from the secondary device (104) to the remote device (106).

At 909, when the call is pulled from the primary device (102), a media session is terminated between the primary device (102) and the secondary device (104) at 910.

At 910, the media session between the primary device (102) and the secondary device (104) is terminated, and the call is pulled from the primary device (102), then the media parameters are negotiated based on the primary device (102) and the remote device (101, 105) capability information at 911.

At 911, media parameters are re-negotiated based on the primary device (102) and the remote device (106,105) capability information (such as Vilte/Volte).

At 912, the media parameters flow between the remote device (106/105) and the primary device (102) based on the re-negotiated media parameters.

At 913, when the call is pulled from the secondary device (104), then the CMC media session is initiated between the primary device (102) and the secondary device (104). When the call is not pulled from the secondary device (104), then again media flows between the remote device (106) and the primary device (102) until the call is pulled from the secondary device.

When the call is pulled from the secondary device (104), the CMC media session is initiated between the primary device (102) and the secondary device (104), and the media parameters are re-negotiated based on the secondary device (104) and the remote device (105,106) capability information and same media parameters are maintained in the Vilte and CMC session (at 907).

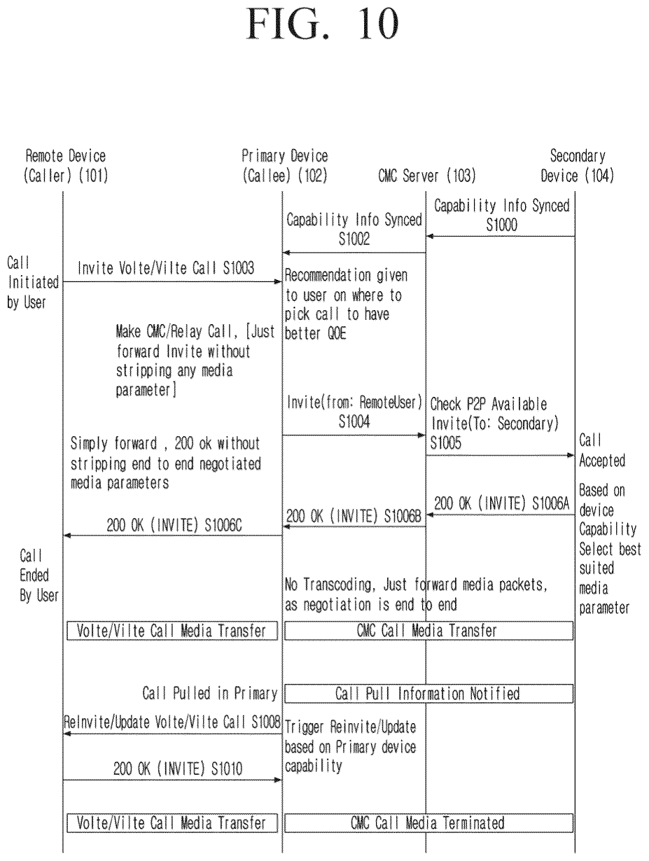

FIG. 10 is a sequence diagram illustrating an instance of receiving the call in the secondary device (104) and later pulled in the primary device (102), according to the embodiments herein.

Referring to FIG. 10, capability information of the secondary devices (104) is synched with primary device (102) via the CMC server on a demand basis, periodically, or one time during the device registration with the CMC server. The remote device (101) or the caller device (102) initiates call to the primary device (102). The receiver devices (102, 104) receive a notification of the call on the primary device (102) and all the connected secondary devices (104). The primary device (102) receives additional notification on the recommendation of the optimal secondary device (104) where the call can be picked to have better quality of experience. In one or more examples, the user accepts the call from the secondary device (104) (at the receiver end). The call is established between the secondary device (104) and the remote device or the caller device (101) (the primary device (102) can act as a relay).

At S1000 and S1002, the CMC server (103) collects the capability information from all the secondary devices (104). The capability information can be media parameters of the devices, audio capabilities, video calling capabilities, haptic, text, sensor, 3D or 360 calling capabilities and the like. The capability information of all the devices is synced with the connected primary device (102). The connected primary device (102) is the device to which all the secondary devices (104) are connected (e.g., the device whose credentials are used in all secondary device for connecting to common network). The capability information can be synced on demand, periodically, or on a time basis. The time basis is the time stamp at which the capability information is transmitted. The capability information is collected by the CMC server (103) and stored. The capability information is also synced with the primary device (102) through the CMC server (103).

At S1003, the call is initiated by the remote device (101) or the caller device (101). The invite Volte/Vilte call is transmitted to the primary device (102). The primary device (102) also provides a recommendation to the user. The recommendation can include the optimal secondary device (104) (e.g., recommended device) on which the user receives the call. The recommended device can include a better Quality of Experience (QoE) compared to available devices. The recommended device can be the primary device (102), secondary device (104).

At S1004, an invite is received in the primary device (102), the primary device (102) initiates a new CMC call to all connected secondary devices (104) by sending SIP invite message by copying all media parameters (e.g., without stripping/modifying any of the parameters) which it received from remote device. The SIP may be used to initiate and manage communication sessions.

At S1005, Point to Point (P2P) availability is checked at the CMC server (103). The extended invite is transmitted to available secondary devices from the CMC server (103).

At S1006A, S1006B, and S1006C, the secondary device (104) accepts the call based on the recommendation and then forwards acceptance notification to primary device (102), where subsequently, the primary device (102) forwards the invite to the remote device (101) without striping end to end negotiated media parameters. The invite can be 200 OK. The 200 OK messages are part of the process of establishing a communication session. The secondary device (104) selects the best suited media parameter based on the capability information received from the remote device devices and from its own capability. The media parameters can be codec resolution, fps, sampling rate, and content information for the CMC and operator network session and the like. The media is flown between the caller device (101) and the secondary device (104) based on the negotiated parameters.

The primary device (102) acts as a relay and do not decode/encode/depacketize/packetize/depacketize any media packets simply forward media packets from the remote device (101) to or from the secondary device (104).

At S1008, the call is pulled in primary device (102) from secondary device, a new invite message is sent to remote device (101) from primary device and existing CMC session between secondary device (104) and primary device (102) is terminated. In one or more examples, media parameters may be re-negotiated based on primary device (102) and remote device (101) capability, media also flow between primary and remote device based on negotiated media parameters. In one or more examples, for re-negotiation, the SIP re-invite/update method can be used.

The call is ended by the remote device (101) or the caller device (101). When the call is ended by the remote user, both the Volte and the CMC session get cleared and the user is notified on all the devices.

The secondary device (104) capabilities synced with connected primary device (102) (On demand/periodic/One time basis). The primary device's (102) number is dialed, and the call is made from the remote device (101), and the SIP invite message is sent from the remote device (101) to the primary device (102)). The invite may be received in the primary device (102), and recommendation is given to the user on the primary device (102), on which device user needs to pick the call to have better QOE. The primary device (102), without stripping any media parameters from received invite, forwards the media parameters to the secondary device (104) via CMC server. The call rings on the secondary device (104) and the user picks up the call on the secondary device (104). The secondary device (104) selects best suited media parameter based on device capability and sends 200 OK with that info. The primary device (102) forwards 200 OK without stripping any media parameters. The media flows between the remote device (101) and the secondary device (104). The primary device (102) acts as a relay, decodes/encodes/depacketizes/packetizes any media packets, and forwards media packets from remote to/from to secondary. At S1008, the call is pulled in primary device (102) from secondary device, a new invite message is sent to remote device (101) from primary device and existing CMC session between secondary device (104) and primary device (102) is terminated. In one or more examples, media parameters are re-negotiated based on primary device (102) and remote device (101) capability. Media may also flow between the primary and remote device based on negotiated media parameters. At S1010, the remote device (101) establishes the modified connection with the primary device (102) with the invite message, and the Volte/Vilte call media is transmitted based on re-negotiated media information once the communication is accepted. The CMC call media is terminated between the secondary device (104) and the primary device (102).

There are a few reasons why a user may pick a call on secondary device rather than primary device. For example, the user may be closer to the secondary device (104), or the user can find the secondary device more easily than the primary device (102). In another example, the primary device (102) battery may be low. When the display is active for more duration, then the battery drains faster. The secondary device (104) has more capability (Display/CPU/RAM) than the primary device (102). The call is for other family member, who can pick call from the secondary device (104) without disturbing the user activity in the primary device (102).

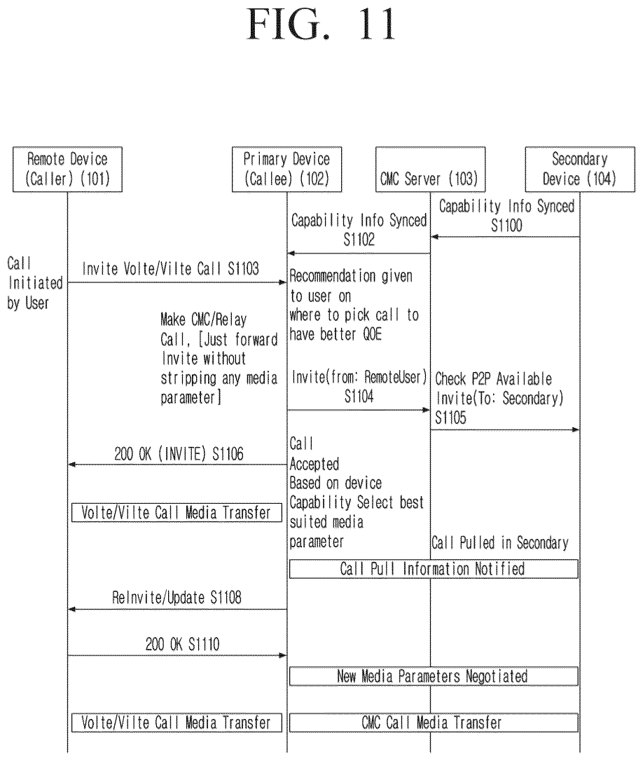

FIG. 11 is a sequence diagram illustrating an instance of receiving the call in the primary device (102) and later pulled in the secondary device (104), according to the embodiments herein.

The receiver device (102, 104) receives notification of the call on the primary device (102) and all the connected secondary devices (104). The primary device (102) receives additional notification on the recommendation of the optimal secondary device (104). In one or more examples, the user accepts the call from the primary device (at the receiver end). The call is established between the primary device and the remote device (101) or the caller device

At S1100 and S1102, the CMC server (103) collect the capability information from all the secondary devices (104). The capability information can be the media parameters of the devices, audio capabilities, video calling capabilities, haptic, text, sensor, 3D or 360 calling capabilities and the like. The capability information of all the devices is synced with the connected primary device (102). The connected primary device is the device to which all the secondary devices (104) are connected (e.g., the device whose credentials are used in all secondary device for connecting to common network). The capability information can be synced on demand or periodic or on time basis. The time basis is the time stamp at which the capability information is transmitted. The capability information is collected by the CMC server (103) and stored. The capability information is also synced with the primary device (102) through the CMC server (103).

At S1103, the call is initiated by the remote device (101) or the caller device (101). The invite Volte/Vilte call is transmitted to the primary device (102). The primary device (102) also provides recommendation to the user. The recommendation can include the optimal secondary device (104) (recommended device) on which the user receives the call. The recommended device can include a better Quality of Experience (QoE) compared to available devices.

At S1104, the invite is received in the primary device (102), the primary device (102) initiates a new CMC call to all connected secondary devices (104) by sending an SIP invite message, where the primary device copies all media parameters (i.e., without stripping/modifying any of the parameters) which it received from remote device. The SIP is used to initiate and manage communication sessions.

At S1105, Point to Point (P2P) availability is checked at the CMC server (103). The secondary or extended invite is transmitted to available secondary devices from the CMC server (103).

At S11066, the call is accepted in the primary device (102), the primary device (102) forwards the accepted response back to the remote device (101) without striping end to end negotiated media parameters. The response can be 200 OK. The 200 OK messages are part of the process of establishing a communication session. The primary device (102) selects the best suited media parameter based on the capability information received from remote device devices and from the device's own capability. The media parameters can be codec resolution, fps, sampling rate, and content information for the CMC and operator network session and the like. The media is flown between the caller device and the primary device based on the negotiated capability information.

After sometime, the call is pulled from Secondary device (104), a new CMC call is established between Secondary device (104) and primary device (102). In one or more examples, the media parameters are re-negotiated based on remote device (101) and secondary device (104) capability. Re-negotiation of the media parameters may also happen between primary (102) and remote device in operator network call based on secondary (104) and remote device (101) capability. In one or more examples, for re-negotiation, SIP re-invite/update method can be used.

The primary device (102) acts as a relay and does not decode/encode/depacketize/packetize/depacketize any media packets, but simply forwards media packets from the remote device (101) to or from the secondary device (104).

The secondary device (104) capabilities may be synced with the connected primary device (102) (On demand/Periodic/One time basis). The primary device's (102) number is dialed and the call made from the remote device (101) (SIP invite message sent from the remote device to the primary device). The invite is received in the primary device (102), and recommendation given to the user on the primary device (102), on which the device user need to pick the call to have better QoE, call is accepted in the primary device (102). The primary device (102) selects the best suited media parameter based on the capability information received from remote device devices and from the device's own capability, and sends selected media parameter information in 200OK, media flow between primary device (102) and remote device (101). After sometime, call is pulled from Secondary device (104), a new CMC call is established between Secondary device (104) and primary device (102). In one or more examples, media parameters are negotiated based on remote device (101) and secondary device (104) capability. In one or more examples, the media flows between the remote device (101) and the secondary device (104).

The primary device (102) may act only as a relay, and does not decode/encode/depacketize/packetize any media packets, but simply forwards media packets from the remote to/from the secondary device (104). The user pulled the call from the primary device (102) and the primary device (102) re-negotiate the media parameters with the remote device (101), when new media parameter better suited than old parameter are found, which are currently in use. The media session is terminated between the primary device (102) and the secondary device (104). The media transmission/reception is performed between the remote device (101) and the primary device (102) based on the new negotiation. The primary device may be chosen based on one of the below reasons:

The secondary device battery is low.

The primary device (102) has more capability (Display/CPU/RAM) than the secondary.

The Wi-Fi strength is weak in the secondary device.

In these cases, a re-invite/update triggered from the primary device (102) may be performed to re-negotiate media parameters between the primary device (102) and the remote device (101).

The secondary device capability information may be synced with the connected primary device (102) (on demand/periodic/on time basis). The primary device's (102) number is dialed, and the call is made from the remote device (SIP invite message sent from the remote device (101) to the primary device (102). The invite is received in the primary device (102), the recommendation given to the user on the primary device (102), on which the user needs to pick the call to have the better QoE. The primary device (102), without stripping any media parameters from the received invite, simply forwards to the secondary device (104). The call rings on the secondary device (104) and as well as on the primary device (102). The user may ignore the recommendation and receive the call in the primary device (102). The primary device (102) negotiates media parameters with the remote device (101) based on the media capabilities of primary and remote device. The media flows between the remote device (101) and the primary device (102) based on the negotiated media parameters.

The user pulls the call from the secondary device (104). The call pull information is notified to the primary device (102). The primary device (102) re-negotiate media parameters with the remote device (101) and the secondary device (104), based on the secondary device (104) and the remote device capability. The media flows between the remote device (101) and the secondary device (104) based on the new media parameter negotiation. The primary device (102) acts as relay, and does not decode/encode/depacketize/packetize any media packets, but simply forwards media packets from the remote to/from the secondary device (104).

The user initially accepted call in the primary device (102) (as the user is closer to the primary device), but later, the user may pull the call in the secondary device because of one of the below reasons:

The primary device (102) battery is low (if the display is active for more duration, then it will drain faster).

The secondary device (104) includes more capability information (Display/CPU/RAM) than the primary device (102).

The call is for other family member, who can pick the call from the secondary device (104) without disturbing user activity in the primary device (102).

In this case, a re-invite/update triggered from the primary device (102) may be performed to re-negotiate media parameters between the primary device (102) and the remote device (101).

The QoE for the user is improved as the call is established based on end device capability (not dependent on intermediate device). Effective usage of secondary device capability (Like VST, VR/AR device). End to End delay & power usage is reduced as no extra processing in the primary device (102). The user is guided on which device to pick to have a better experience, which improves overall quality of service in the CMC. The CMC feature usage increases as features can be extended to all devices in advance.

Secondary device (104) needs to sync their media capability with connected/associated primary device (102). Secondary device (104) capability sync can happen in 3 ways:

One Time: As soon as secondary device (104) registers with CMC server, its media capability info will be synced with primary device (102) via CMC server.

On Demand: If Primary device (102) finds capability of secondary device (104) which it received earlier is corrupt or not complete, then it can query and get media capability info from secondary device (104).

Periodic: Secondary device periodically (e.g, one in 10 min or 1 hour) sync media capability info with primary device (102) via CMC server.

Syncing the media capability will help primary device (102) in below ways:

As soon as incoming invite is received, based on secondary device (104) capability it has, it can recommend in which device call need to be picked up to have better QOE

It can decide if media parameters in invite/update message need to be stripped or retained, before forwarding invite/update message to secondary.

In call pull scenario, as it already has secondary device (104) capability information, it will help in negotiating new media parameters with remote device (101).

In CMC, JSON format is already used to sync contact and message details from secondary device to primary device. Information shared as Name and Value pair. For example:
‘9-02 15:08:55.804 6878 9472 I [NMS2]VolleyCntlr:[0057](=>)
PostRequest={“object”:{“correlationTag”:“8d23b0223d218ffa”,“flags”:{
“flag”:[“\\Seen”]},“attributes”:{“attribute”:[{“name”:“Call-
Disposition”,“value”:[“OUTGOING”]},{“name”:“Call-
DispositionExt”,“value”:[“2”]},{“name”:“Call-
Duration”,“value”:[“29”]},{“name”:“Call-
Type”,“value”:[“volte”]},{“name”:“Call-
TypeExt”,“value”:[“1000”]},{“name”:“Date”,“value”:[“2022-09-
02T06:08:21.761Z”]},{“name”:“Device-
Name”,“value”:[“d75f03603652443e31b44bc11714211a97f71a197b835
0b8eff4b49a8c1bd98b”]},{“name”:“Direction”,“value”:[“OUT”]},{“nam
e”:“Emergency”,“value”:[“false”]},{“name”:“From”,“value”:[“+8210577
24901”]},{“name”:“Message-Context”,“value”:[“x-call-
log”]},{“name”:“Presentation”,“value”:[“1”]},{“name”:“Sim_id”,“value”
:[“1”]},{“name”:“To”,“value”:[“01033903474”]}]}}}’

For media capability sync the method is extended (that is capability info shared using JSON format as Name, Value Pair)

For example: when the secondary device (104) supports 720p video resolution and EVS audio codec, then the JSON content may be as follows:
‘PostRequest={“object”:{“MediaCapability”:“8d23b0223d218ffa”},“attri
butes”:{“attribute”:[{“name”:“Video_Width”,“value”:[“720”]},{“name”:“
Video_Height”,“value”:[” 1280”]},
{“name”:“Video_FPS”,“value”:[“30”]},{“name”:“Video_Codec”,“value”:
[“H265”]},{“name”:“Audio_Codec”,“value”:[“EVS”]}]}}’

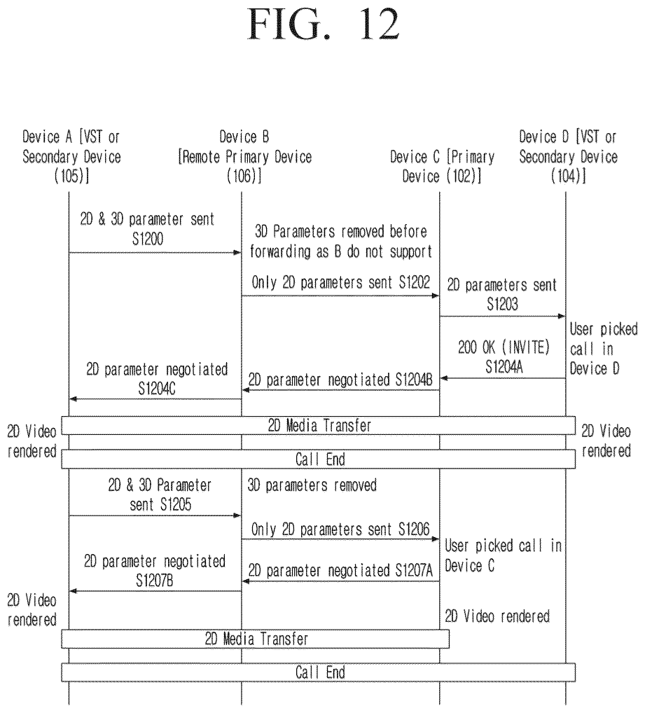

FIG. 12 is a sequence diagram illustrating an instance of a 360 degree or 3D video call between the electronic devices.

At S1200, the device A and device D (caller secondary device and the callee secondary device) can be VST/AR/VR device which supports 2D and 360 kind of decoding and rendering. The device B and device C (caller primary device (102) and the callee primary device) includes mobile device with the SIM, which supports only 2D decoding and rendering. The user initiates the call from the device A (VST) to device C. The call ringing in both the devices C and D, as the device C and D are connected.

At S1202, S1203 and S1204A, the user decides to receive the call from the device D (VST). The 2D parameters are negotiated (at S1204B), as the device B, before sending the invite to device C strips 3D/360 media parameters as the device B do not support the 3D/360 media parameters.

2D media flow between device A (VST) and Device D (VST) the call ends and new call is initiated from the device A to device C. This time, the user receives the call from device C and 2D Parameters get negotiated (at S1204C).

At S1205, the device is capable of decoding and rendering 360 and 2D media parameters makes the call to either device C or device D and always ends up negotiating the 2D media parameters (for transmission, reception and rendering). At S1206 and S1207, even though device A and device D is capable of the 360-video decoding and rendering, the capabilities are not used to provide the better QoE to the user.

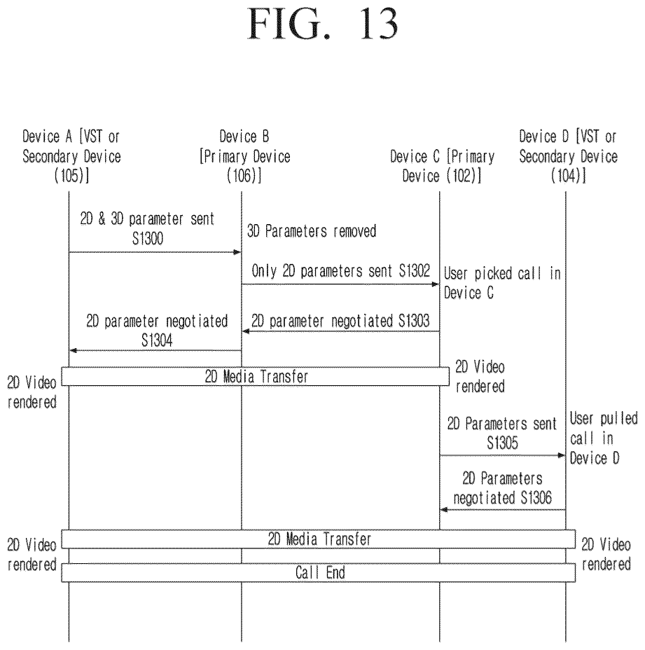

FIG. 13 is a sequence diagram illustrating an instance of the call pull in a case of 360 degree or 3D video call between the electronic devices.

At S1300, the device A and device D (Secondary Devices) can be VST/AR/VR device which supports 2D and 360 decoding and rendering. The device B and device C (Primary Device) includes mobile device with SIM, which supports only 2D decoding and rendering. The user makes a call from device A (VST) to device C and the call ringing in both device C and device D as both are connected.

At S1302, the user decided to pick the call from device C. At S1303, the 2D parameters are negotiated, as device B, before sending invite to the device C strips 3D/360 media parameters as device B do not support it. At S1304, the 2D parameters are negotiated, as device A.

At S1305 and S1306, after some time, user decides to receive the call from device D (pull call from device C). Again, the 2D media parameters negotiated even though A and D both support 360 video decoding and rendering.

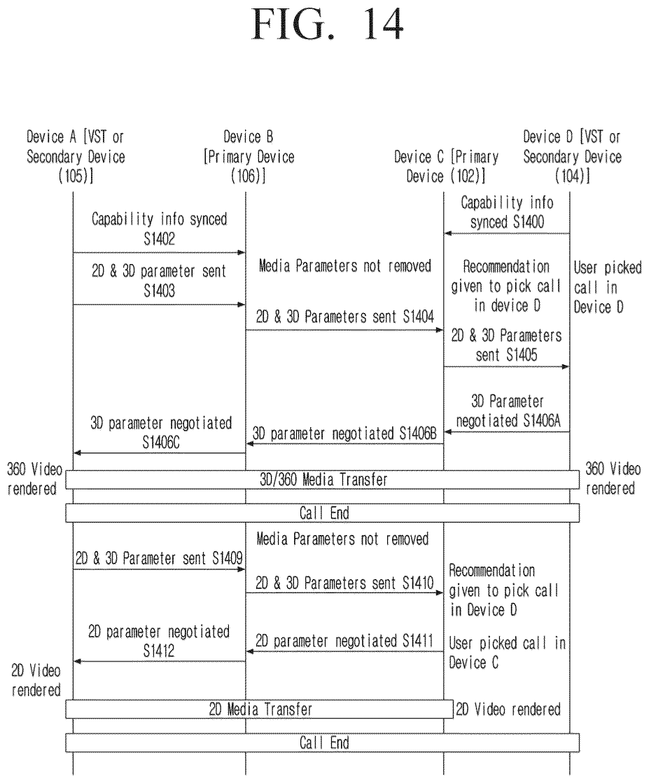

FIG. 14 is a sequence diagram illustrating an instance of a 360 degree or 3D video call between the electronic devices based on capabilities synced with associated the primary device (102), according to the embodiments herein.

At S1401-S1402, the secondary device (104) capabilities are synced with associated with the primary device (102) (device D with device C & device A with device B).

At S1403-S1404, the user makes the call from device A (105) (VST) to device C (102). The call ringing in both device C (102) and device D (104) as both are connected, and recommendation given to the user to pick the call from device D (104) to have better QoE. Based on the recommendation, the user decides to receive call from the device D (104) (VST).

At S1405, the 3D/360 parameters are negotiated, this is because Device B or Device C will not strip any media parameters even though they don't support it, device A (105) and device D (104) conversation happens with the 3D/360 media parameters, device B and device C acts as relay, simply forwards packets to the device A and device D with very less or zero processing.

At S1406A, S1406B, and S1406C, the call ends and new call is initiated from device A to device C. The user ignored recommendation and receives call from device C (102) and 2D parameters are negotiated for transmission and reception.

At S7, using above method, the capabilities are fully utilized provided by VST or any advanced AR/VR/XR devices to give better quality of experience to user.

At S1405, S1406A, S1406B, and S1406C-trigger Point: the user can receive call in the device D (104) because of one of the below reasons (few examples):

The user is close to the device D (104) (or user can find device D (104) more easily than the device c (primary device) (102)).

The device c (primary device) (102) battery is low (when the display is active for more duration than the battery drained faster).

The device D (secondary device) (104) has more capability (Display/CPU/RAM) than the primary device (102).

The call is for other family member, who can pick call from the device D (104) (secondary device) without disturbing user activity in the primary device (102).

The user can receive the call in the device C (102) (Trigger point for S1410 & S1411) primary device because of one of the below reasons (few examples):

The device D (104) (secondary device) battery is low

Primary device (102) has more capability (Display/CPU/RAM) than secondary

Wi-Fi strength is weak in the device D (secondary device (104)).

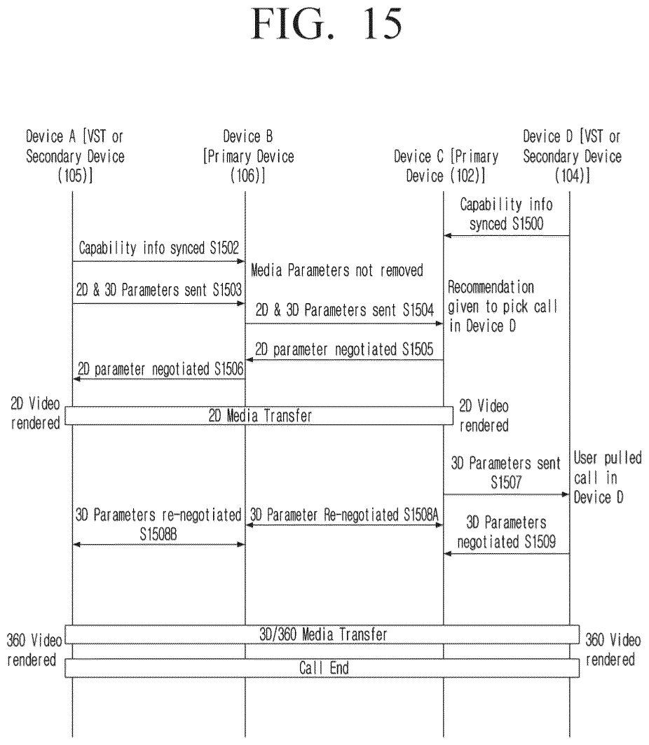

FIG. 15 is a sequence diagram illustrating an instance of a call pull in a case of 360 degree or 3D video call between the electronic devices based on capabilities synced with associated the primary device (102), according to the embodiments herein.

At S1500-S1502, the secondary device (104) capabilities synced with correspond primary device (102) (device D with device C and device A with device B). The user makes the call from device A (VST) to device C. At S1503 and S1504, the call is ringing in both device C and device D as both are connected, the recommendation given to the user to receive the call from device D to have better QoE. Initially the user decided to receive call from the device C.

At S1505-S1506, the 2D parameters negotiated for transmission and reception. After some time, user decides to receive the call from device D (pull call from device C). The 3D/360 parameters renegotiated, and device A and device D conversation is performed with the 3D/360 media parameters (device B and device C acts as relay, simply forwards packets to the secondary device). Here, when the call is between the device A and device D (2 VST device), the capability is fully utilized to give better QoE.

At S1504-S1505, the user accepts the call in the primary device (102) (as the primary device (102) is closer to the user) later he pulled the call in the secondary device because of one of the below reasons (few examples):

1. The primary device (102) battery is low (when the display is active for more duration, then the battery is drained faster).

2. The secondary device have more capability (Display/CPU/RAM) than the primary device (102).

3. The call is for other family members, who can pick call from secondary device without disturbing the user activity in the primary device (102).

4. The primary device (102) is needed for some other purpose (like Kid/spouse need it) and secondary device is free.

The present disclosure includes a recommendation of an optimal electronic device on which the quality of experience (QoE) is better. A recommendation notification is displayed to the user on the primary device (102), recommending the optimal electronic device to receive the call.

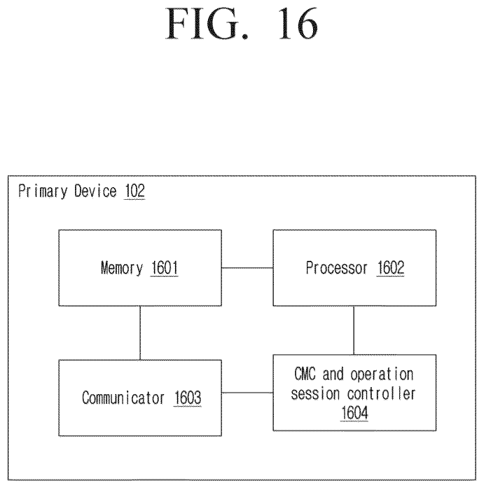

FIG. 16 is a block diagram illustrating a primary device (102) for managing CMC session between the primary device (102) and secondary devices (104), according to the embodiments herein.

The primary device (102) includes a memory (1601), a processor (1602), a communicator (1603), and a CMC and operation session controller (1604).

The memory (1601) is configured to store instructions to be executed by the processor (1602). The memory (1601) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (1601) may, in some examples, be considered a non-transitory storage medium. The term “non-transitory” may indicate that the storage medium is not embodied in a carrier wave or a propagated signal. However, the term “non-transitory” should not be interpreted that the memory (1601) is non-movable. In some examples, the memory (1601) is configured to store larger amounts of information. In certain examples, a non-transitory storage medium may store data that can, over time, change (e.g., in Random Access Memory (RAM) or cache).

The processor (1602) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor (1602) such as a neural processing unit (NPU). The processor (1602) may include multiple cores and is configured to execute the instructions stored in the memory (1601).

The communicator (1603) (e.g., communication circuitry) includes an electronic circuit specific to a standard that enables wired or wireless communication. The communicator (1603) is configured to communicate internally between internal hardware components such as for example the memory (1601), the processor (1602), the CMC and operation session controller (1604) and with external devices via one or more networks.

The CMC and operation session controller (1604) receives and stores media capability information received from all connected secondary devices, it determines the optimal secondary device based on the capability information and the media parameters received from the remote device (101) and Capability information of secondary devices to establish the CMC session with the optimal secondary device. In one or more embodiments, the optimal secondary device can be determined based on a user input. For example, a user interface or a notification or pop up can be displayed on the primary device (102) to select the optimal secondary device.

The CMC and operation session controller is responsible for starting and ending CMC and IMS based (operator network based) session based on user action and it can also modifying or re-negotiate media parameters of both session (CMC and operator network) based on end device capabilities. The CMC and operation session controller (1604) receives the communication accept message from the CMC server, and the communication accept message includes negotiated media parameter. The communication request message includes the media parameters that is forwarded to the optimal secondary device without stripping any of the media parameters received in the communication request message. The communication accept message includes negotiated media parameter forwarded to the remote device (101) without stripping any of the at least one negotiated media parameter received in the communication accept message. The CMC and operation session controller (1604) facilitates the media data transfer between the remote device (101) and the optimal secondary device.

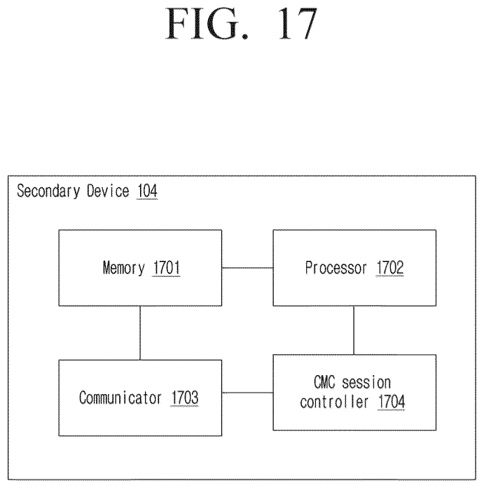

FIG. 17 is a block diagram illustrating the secondary device (104) for managing CMC session between the primary device (102) and secondary devices (104), according to the embodiments herein.

The secondary device (104) includes a memory (1701), a processor (1702), a communicator (1703), and a CMC session controller (1704).

The memory (1701) is configured to store instructions to be executed by the processor (1702). The memory (1701) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (1701) may, in some examples, be considered a non-transitory storage medium. The term “non-transitory” may indicate that the storage medium is not embodied in a carrier wave or a propagated signal. However, the term “non-transitory” should not be interpreted that the memory (1701) is non-movable. In some examples, the memory (1701) is configured to store larger amounts of information. In certain examples, a non-transitory storage medium may store data that can, over time, change (e.g., in Random Access Memory (RAM) or cache).

The processor (1702) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor (1702) such as a neural processing unit (NPU). The processor (1702) may include multiple cores and is configured to execute the instructions stored in the memory (1701).

The communicator (1703) includes an electronic circuit specific to a standard that enables wired or wireless communication. The communicator (1703) is configured to communicate internally between internal hardware components such as for example the memory (1701), the processor (1702), the CMC controller (1704) and with external devices via one or more networks.

The CMC session controller (1704) sends media capability information of all connected secondary devices to primary device via CMC server, The CMC session controller (1704) receives the communication request message from the CMC server, and the communication request message includes media parameter of remote device. It also sends accept message to primary device via CMC server, the communication request message includes negotiated media parameter which are selected based on remote and secondary device capability. The CMC session controller (1704) facilitates the media data transfer between the primary device and the optimal secondary device. The CMC controller is responsible for starting and ending CMC session between primary and secondary device, and it can also modifying or re-negotiate media parameters of CMC session based on end device capabilities.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A primary device for managing a Call and Message Continuity (CMC) session, comprising:
memory storing one or more instructions;
at least one processor;
communication circuitry; and
a CMC controller communicatively coupled to the memory, the at least one processor and the communication circuitry,
wherein the one or more instructions, when executed by the CMC controller, cause the primary device to:
receive, capability information of a plurality of secondary devices from a CMC server;
receive a communication request message from a remote device to establish an operator network session and the CMC session with the primary device, wherein the communication request message comprises a plurality of media parameters of the remote device;
select a secondary device from the plurality of secondary devices based on the capability information of each of the plurality of secondary devices and the plurality of media parameters received from the remote device;
establish the CMC session with the selected secondary device by forwarding the communication request message comprising the plurality of media parameters to the CMC server;
receive a communication accept message from the CMC server, wherein the communication accept message comprises at least one negotiated media parameter from the plurality of media parameters by the selected secondary device for the CMC session;
forward the communication accept message received from the CMC server to the remote device; and
initiate a media data transfer between the remote device and the selected secondary device.

2. The primary device as claimed in claim 1, wherein the communication request message comprising the plurality of media parameters is forwarded to the selected secondary device without stripping any of the plurality of media parameters received in the communication request message.

3. The primary device as claimed in claim 1, wherein the communication accept message comprising the at least one negotiated media parameter is forwarded to the remote device without stripping any negotiated media parameter received in the communication accept message.

4. The primary device as claimed in claim 1, wherein the one or more instructions, when executed by the CMC controller to initiate the media data transfer between the remote device and the selected secondary device, further cause the primary device to:
receive one or more media data packets from the remote device during the operator network session, wherein the one or more media data packets are to be transmitted to the selected secondary device; and
forward the one or more media data packets received from the remote device to the selected secondary device during the CMC session, wherein the one or more media data packets are forwarded to the selected secondary device without transcoding any of the one or more media data packets by the primary device.

5. The primary device as claimed in claim 1, wherein the one or more instructions, when executed by the CMC controller to initiate the media data transfer between the remote device and the selected secondary device, further causes the primary device to:
receive one or more media data packets from the selected secondary device during the CMC session, wherein the one or more media data packets are transmitted to the remote device; and
forward the one or more media data packets received from the selected secondary device to the remote device during the operator network session, wherein the one or more media data packets are forwarded to the remote device without transcoding any of the one or more media data packets by the primary device.

6. The primary device as claimed in claim 1, wherein the one or more instructions, when executed by the CMC controller further cause the primary device to:
detect a trigger event associated with the selected secondary device;
transmit a communication-pull notification message to the selected secondary device;
terminate the CMC session between the primary device and the selected secondary device;
renegotiate at least one selected media parameter from the plurality of media parameters for the operator network session with the remote device based on the capability information of the primary device; and
continue the media data transfer between the primary device and the remote device based on the at least one negotiated media parameter.

7. The primary device as claimed in claim 1, wherein the one or more instructions, when executed by the CMC controller further cause the primary device to:
detect a trigger event associated with the primary device;
establish the CMC session between the primary device and the selected secondary device;
renegotiate at least one media parameter from the plurality of media parameters for the CMC session and the operator network session with the remote device based on the capability information of at least one secondary device from the plurality of secondary devices; and
continue the media data transfer between the remote device and the secondary device based on the at least one negotiated media parameter.

8. The primary device as claimed in claim 7, wherein the trigger event is at least one of (i) a level of a battery of the selected secondary device meets a battery threshold, (ii) detecting that a capability of the primary device is more than a capability of the selected secondary device, and (iii) a communication signal strength of the selected secondary device meets a signal strength threshold.

9. The primary device as claimed in claim 1, wherein the plurality of media parameters comprises a codec resolution, frames per second, a sampling rate, and content information.

10. A method for managing a Call and Message Continuity (CMC) session, comprising:
receiving, by a primary device, capability information of a plurality of secondary devices from a CMC server;
receiving, by the primary device, a communication request message from a remote device to establish the CMC session with the primary device, wherein the communication request message comprises a plurality of media parameters of the remote device;
selecting, by the primary device, a secondary device from the plurality of secondary devices based on the capability information of each of the plurality of secondary devices and the plurality of media parameters received from the remote device;
establishing, by the primary device, the CMC session with the selected secondary device by forwarding the communication request message comprising the plurality of media parameters to the CMC server;
receiving, by the primary device, a communication accept message from the CMC server, wherein the communication accept message comprises at least one negotiated media parameter from the plurality of media parameters by the selected secondary device for the CMC session;
forwarding, by the primary device, the communication accept message received from the CMC server to the remote device; and
initiating, by the primary device, media data transfer between the remote device and the selected secondary device.

11. The method as claimed in claim 10, wherein the communication request message is received from the remote device to establish an operator network session with the primary device.

12. The method as claimed in claim 10, wherein the communication request message comprising the plurality of media parameters is forwarded to the selected secondary device without stripping any of the plurality of media parameters received in the communication request message.

13. The method as claimed in claim 10, wherein the communication accept message comprising the at least one negotiated media parameter is forwarded to the remote device without stripping any negotiated media parameter received in the communication accept message.

14. The method as claimed in claim 10, wherein the initiating, by the primary device, the media data transfer between the remote device and the selected secondary device further comprises:
receiving, by the primary device, one or more media data packets from the remote device during an operator network session, wherein the one or more media data packets are to be transmitted to the selected secondary device; and
forwarding, by the primary device, the one or more media data packets received from the remote device to the selected secondary device during the CMC session, wherein the one or more media data packets are forwarded to the selected secondary device without transcoding any of the one or more media data packets by the primary device.

15. The method as claimed in claim 10, wherein the initiating, by the primary device, the media data transfer between the remote device and the selected secondary device further comprises:
receiving, by the primary device, one or more media data packets from the selected secondary device during the CMC session, wherein the one or more media data packets are to be transmitted to the remote device; and
forwarding, by the primary device, the one or more media data packets received from the selected secondary device to the remote device during an operator network session, wherein the one or more media data packets are forwarded to the remote device without transcoding any of the one or more media data packets by the primary device.

16. A non-transitory computer readable medium having instructions stored therein, which when executed by a Call and Message Continuity (CMC) controller for managing a CMC session, cause the CMC controller to execute a method comprising:
receiving, by a primary device, capability information of a plurality of secondary devices from a CMC server;
receiving, by the primary device, a communication request message from a remote device to establish the CMC session with the primary device, wherein the communication request message comprises a plurality of media parameters of the remote device;
selecting, by the primary device, a secondary device from the plurality of secondary devices based on the capability information of each of the plurality of secondary devices and the plurality of media parameters received from the remote device;
establishing, by the primary device, the CMC session with the selected secondary device by forwarding the communication request message comprising the plurality of media parameters to the CMC server;
receiving, by the primary device, a communication accept message from the CMC server, wherein the communication accept message comprises at least one negotiated media parameter from the plurality of media parameters by the selected secondary device for the CMC session;
forwarding, by the primary device, the communication accept message received from the CMC server to the remote device; and
initiating, by the primary device, media data transfer between the remote device and the selected secondary device.

17. The non-transitory computer readable medium according to claim 16, wherein the communication request message is received from the remote device to establish an operator network session with the primary device.

18. The non-transitory computer readable medium according to claim 16, wherein the communication request message comprising the plurality of media parameters is forwarded to the selected secondary device without stripping any of the plurality of media parameters received in the communication request message.

19. The non-transitory computer readable medium according to claim 16, wherein the communication accept message comprising the at least one negotiated media parameter is forwarded to the remote device without stripping any negotiated media parameter received in the communication accept message.

20. The non-transitory computer readable medium according to claim 16 wherein the initiating, by the primary device, the media data transfer between the remote device and the selected secondary device further comprises:
receiving, by the primary device, one or more media data packets from the remote device during an operator network session, wherein the one or more media data packets are to be transmitted to the selected secondary device; and
forwarding, by the primary device, the one or more media data packets received from the remote device to the selected secondary device during the CMC session, wherein the one or more media data packets are forwarded to the selected secondary device without transcoding any of the one or more media data packets by the primary device.
